(19) United States
(12) Patent Application Publication
(10) Pub. No.: US 2019/0066956 A1
(43) Pub. Date: Feb. 28, 2019

(54) CONTACT DEVICE AND ELECTROMAGNETIC CONTACTOR USING CONTACT DEVICE

(71) Applicant: FUJI ELECTRIC FA COMPONENTS & SYSTEMS CO., LTD., Tokyo (JP)

(72) Inventors: Koujun KONISHI, Kounosu-city (JP); Yuya SAKURAI, Kounosu-city (JP); Hideo ADACHI, Fukaya-city (JP); Yasuhiro NAKA, Kitamoto-city (JP); Kouetsu TAKAYA, Kounosu-city (JP)

(21) Appl. No.: 16/170,555

(22) Filed: Oct. 25, 2018

Related U.S. Application Data
(63) Continuation of application No. PCT/JP2017/008109, filed on Mar. 1, 2017.

(30) Foreign Application Priority Data
Feb. 10, 2017 (JP) 2017-23024

(51) Int. Cl. H01H 50/02; H01H 50/14; H01H 1/06; H01H 1/58

(52) U.S. Cl. CPC H01H 50/02; H01H 1/58; H01H 1/06; H01H 50/14

(57) ABSTRACT

There is provided a contact device including an accommodating case that accommodates a main contact point mechanism having fixed contacts, an external terminal that is disposed outside the accommodating case, and a terminal board that passes through the accommodating case and electrically connects the fixed contacts and the external terminal together. The terminal board has a bent portion surface-contacting with side surfaces of the accommodating case.

### TECHNICAL FIELD

The present invention relates to a contact device that opens and closes a current path and an electromagnetic contactor using the contact device.

### BACKGROUND ART

For example, a contact device disclosed in PTL 1 of the related art is known as a contact device that opens and closes a current path.

The contact device of PTL 1 includes a main contact point mechanism that has a pair of fixed contacts disposed at a predetermined interval and a movable contact capable of contacting with or separating away from the pair of fixed contacts, an accommodating case that accommodates the main contact point mechanism (referred to as a housing in PTL 1), and an external terminal board that connects the pair of fixed contacts and an external wire together (referred to as a bus bar in PTL 1).

The external terminal board of PTL 1 is an elongated plate-shaped conductive member. A joining side terminal screwed to the fixed contacts is formed on one end side of the external terminal board, and a connection side terminal connected to the external wire is formed on the other end side of the external terminal board. In addition, an insertion hole is formed in the accommodating case, and female screw parts formed in the fixed contacts protrude from the insertion hole to the outside. The joining side terminal of the external terminal board is fixed to the fixed contacts by causing the joining side terminal to abut against the female screw parts of the fixed contacts and screwing the fixing screw, which has passed through the joining side terminal, to a male screw part.

### CITATION LIST

### Patent Literature

PTL 1: JP 2005-38705 A

### SUMMARY OF INVENTION

### Technical Problem

In a case where the external wire is connected to the connection side terminal of the external terminal board or the external wire is removed from the connection side terminal in the contact device of PTL 1, there is a possibility that when fastening and removing a connection screw screwed to the connection side terminal, great torque about the connection side terminal acts on the external terminal board and a joining side terminal side fixed to the fixed contacts deforms by the torque.

In view of the circumstances, an object of the invention is to provide a contact device capable of preventing deformation of a side of a terminal board, which is fixed to a fixed contact, even when great torque acts on the terminal board at the time of connecting an external wire to an external terminal, and an electromagnetic contactor using the contact device.

### Solution to Problem

According to an aspect of the invention to achieve the object, there is provided a contact device including an accommodating case configured to accommodate a main contact point mechanism including a fixed contact; and a terminal board penetrating through an insertion hole formed in the accommodating case, in which one end side of the terminal board is fixed to the fixed contact, and another end side of the terminal board is extending in a direction of separating away from the accommodating case to be electrically connected with an external terminal, and in n a bent portion surface-contacting with a side surface of the accommodating case is formed in the terminal board.

In addition, according to another aspect of the invention, there is provided an electromagnetic contactor comprising the contact device described above and an electromagnet unit configured to move a movable contact disposed to be capable of contacting with or separating away from the fixed contact.

### Advantageous Effects of Invention

The contact device and the electromagnetic contactor using the contact device according to the invention are capable of preventing deformation of the side of the terminal board, which is fixed to the fixed contact, even when great torque acts on the terminal board at the time of connecting the external wire to the external terminal.

### BRIEF DESCRIPTION OF DRAWINGS

FIG. 1 is a perspective view illustrating an electromagnetic contactor of a first embodiment according to the invention;

FIG. 2 is a plan view of the electromagnetic contactor of the first embodiment;

FIG. 3 is a sectional view taken along line A-A of FIG. 2;

FIG. 4 is an exploded perspective view of the electromagnetic contactor of the first embodiment;

FIG. 5 is an enlarged view illustrating an inside of a circle indicated with a reference sign B of FIG. 3;

FIG. 6 is a perspective view illustrating an accommodating case and an external terminal board which configure an electromagnetic contactor of a second embodiment according to the invention;

FIG. 7 is a perspective view illustrating an accommodating case which configures an electromagnetic contactor of a third embodiment according to the invention;

FIG. 8 is a perspective view illustrating an accommodating case which configures an electromagnetic contactor of a fourth embodiment according to the invention;

FIGS. 9A and 9B are perspective views illustrating an electromagnetic contactor of a fifth embodiment according to the invention;

FIG. 10 is a perspective view illustrating an exploded part of an electromagnetic contactor of a sixth embodiment according to the invention;

FIG. 11 is a view immediately after a terminal board of the electromagnetic contactor of the sixth embodiment according to the invention is inserted in an insertion hole;

FIG. 12 is a view illustrating a state where the terminal board of the electromagnetic contactor of the sixth embodiment according to the invention is assembled and a bent portion is sandwiched; and

FIG. 13 is a plan view of FIG. 12.

### DESCRIPTION OF EMBODIMENTS

Next, first to sixth embodiments according to the invention will be described with reference to the drawings. In the following description of the drawings, the same or similar portions are assigned with the same or similar reference signs. However, the drawings are schematic, and it should be noted that a relationship between a thickness and a planar dimension, a ratio between the thicknesses of respective layers, and the like are different from the actual relationship and the actual ratio. Therefore, a specific thickness and a specific dimension should be determined in consideration of the following description. In addition, it is evident that the drawings also include portions having relationships between dimensions and ratios which are different from each other.

In addition, the first to sixth embodiments to be described in the following are merely examples of a device or a method for materializing a technological idea of the invention, and the technological idea of the invention is not limited to the following material, shape, structure, disposition, and the like of a configuring component. Various modifications may be added to the technological idea of the invention without departing from a technological scope defined by claims described in CLAIMS.

### First Embodiment

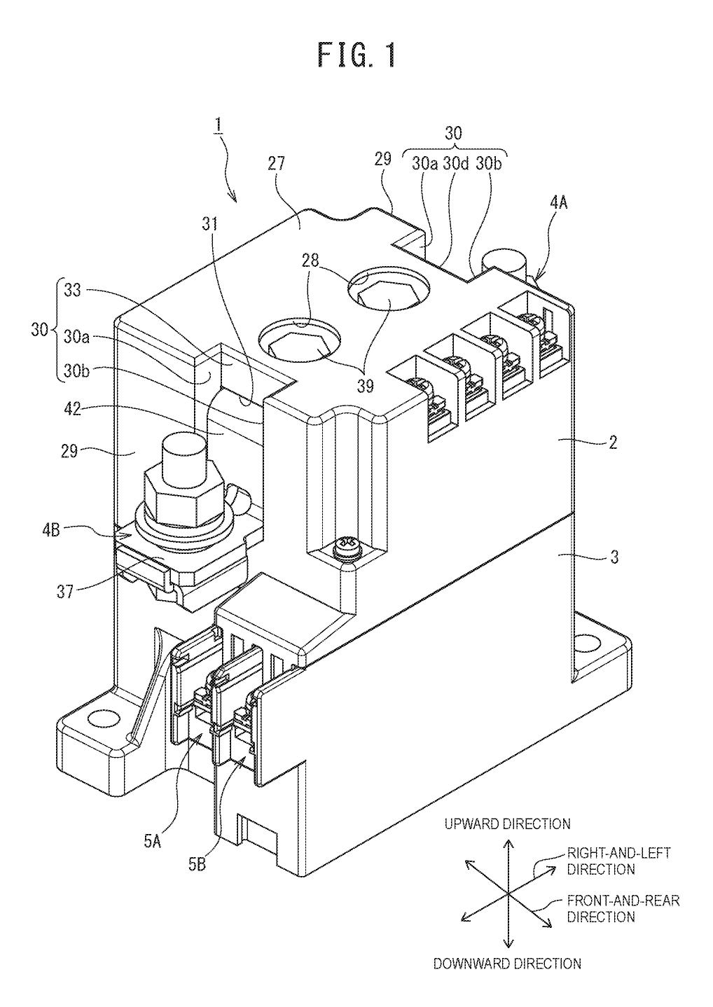

An electromagnetic contactor 1 of the first embodiment will be described with reference to FIGS. 1 to 5.

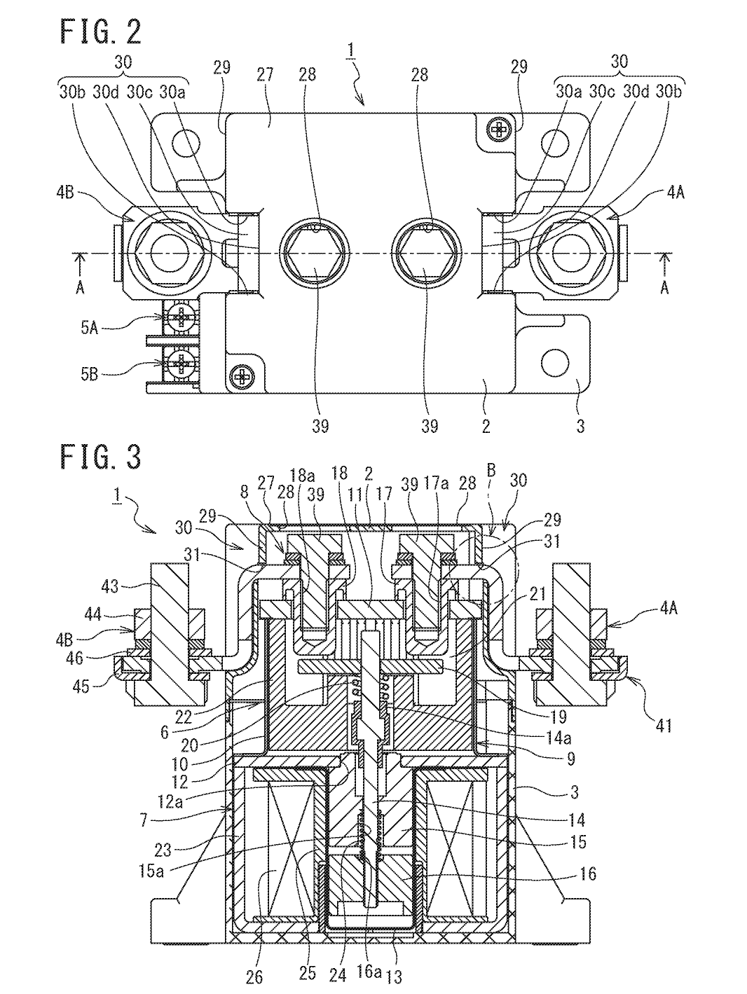

As illustrated in FIGS. 1 and 2, the electromagnetic contactor 1 includes an upper insulating case 2 and a lower insulating case 3, which are synthetic resin mold cases. The main contact point external terminal parts 4A and 4B are disposed in a state of protruding from right and left side walls of the upper insulating case 2, and electromagnet unit external terminal parts 5A and 5B are disposed on one side surface of the lower insulating case 3.

As illustrated in FIG. 3, the upper insulating case 2 and the lower insulating case 3 accommodate a contact device 6 and an electromagnet unit 7 that drives the contact device 6.

The contact device 6 includes a main contact point mechanism 8 and an accommodating case 9.

The accommodating case 9 has a metal bonding member 10 having a square tubular shape, a ceramic top plate 11 which is bonded to an upper end portion of the bonding member 10 and blocks an upper side of the bonding member 10, a flat magnetic yoke 12 having an upper surface which is sealed and bonded to a lower end portion of the bonding member 10, and a cylindrical metal cap 13 which is sealed and bonded to a lower surface of the magnetic yoke 12.

The main contact point mechanism 8, a connection shaft 14 of the electromagnet unit 7, a fixing iron core 15, and a movable plunger 16 are accommodated in a sealed state inside the accommodating case 9, and the accommodating case is filled with an arc-extinguishing gas.

The main contact point mechanism 8 includes a pair of main contact point side fixed contacts 17 and 18 fixed to the top plate 11 and a main contact point side movable contact 19 capable of contacting with or separating away from the pair of the main contact point side fixed contacts 17 and 18. The main contact point side fixed contacts 17 and 18 are formed of a conductive metal and are fixed to the top plate 11 of the accommodating case 9 at a predetermined interval in a right-and-left direction. Fixed contact points are formed on lower end surfaces of the main contact point side fixed contacts 17 and 18.

The main contact point side movable contact 19 is a conductive plate, which is made of a conductive metal and extends long in the right-and-left direction, and is supported by the connection shaft 14 fixed to the movable plunger 16 of the electromagnet unit 7 so as to be vertically movable. A movable contact point contacting with the fixed contact point of the main contact point side fixed contact 17 is formed on a left end upper surface of the main contact point side movable contact 19, and a movable contact point contacting with the fixed contact point of the main contact point side fixed contact 18 is formed on a right end upper surface of the main contact point side movable contact 19.

An enlarged diameter portion 14a is formed below the main contact point side movable contact 19 of the connection shaft 14 so as to protrude radially outward, and a contact spring 20 biasing the main contact point side movable contact 19 upwards is provided between the enlarged diameter portion 14a and the main contact point side movable contact 19.

The main contact point mechanism 8 is accommodated in a main contact point mechanism accommodating chamber 21 provided inside the accommodating case 9. An arc-extinguishing vessel 22 consists of an insulator is disposed in the main contact point mechanism accommodating chamber 21.

The electromagnet unit 7 includes a lower magnetic yoke 23 which is in a U-shape when seen from the side surface. The flat the magnetic yoke 12 is fixed to an upper end of the lower magnetic yoke 23, which is an open end. A through-hole 12a is formed in a middle portion of the magnetic yoke 12.

The bottomed cylindrical cap 13 is sealed and bonded to a middle portion of the lower surface of the magnetic yoke 12 so as to surround the through-hole 12a.

The cylindrical fixing iron core 15 fixed to the through-hole 12a of the magnetic yoke 12 is disposed in the cap 13, and the movable plunger 16 is disposed below the fixing iron core 15 so as to be movable in an up-and-down direction in the cap.

A returning spring accommodating recess 15a which is recessed upwards from a lower end surface of the fixing iron core 15 is formed in the fixing iron core. In addition, a returning spring accommodating recess 16a which is recessed downwards from an upper end surface of the movable plunger 16 is formed in the movable plunger. A returning spring 24 biasing the movable plunger 16 downwards at all times is accommodated in the returning spring accommodating recess 15a and the returning spring accommodating recess 16a.

In addition, a spool 25 is disposed on an outer circumference of the cap 13, and an exciting coil 26 driving the movable plunger 16 is wound around an outer circumference of the spool 25.

End portions of two windings of the exciting coil 26 are connected to the electromagnet unit external terminal parts 5A and 5B illustrated in FIG. 1, respectively.

As illustrated in FIG. 3, the main contact point external terminal parts 4A and 4B described above are fixed to the main contact point side fixed contacts 17 and 18, and protrude from the right and left side walls of the upper insulating case 2 to the outside.

Female screws 17a and 18a are formed in heads of the main contact point side fixed contacts 17 and 18.

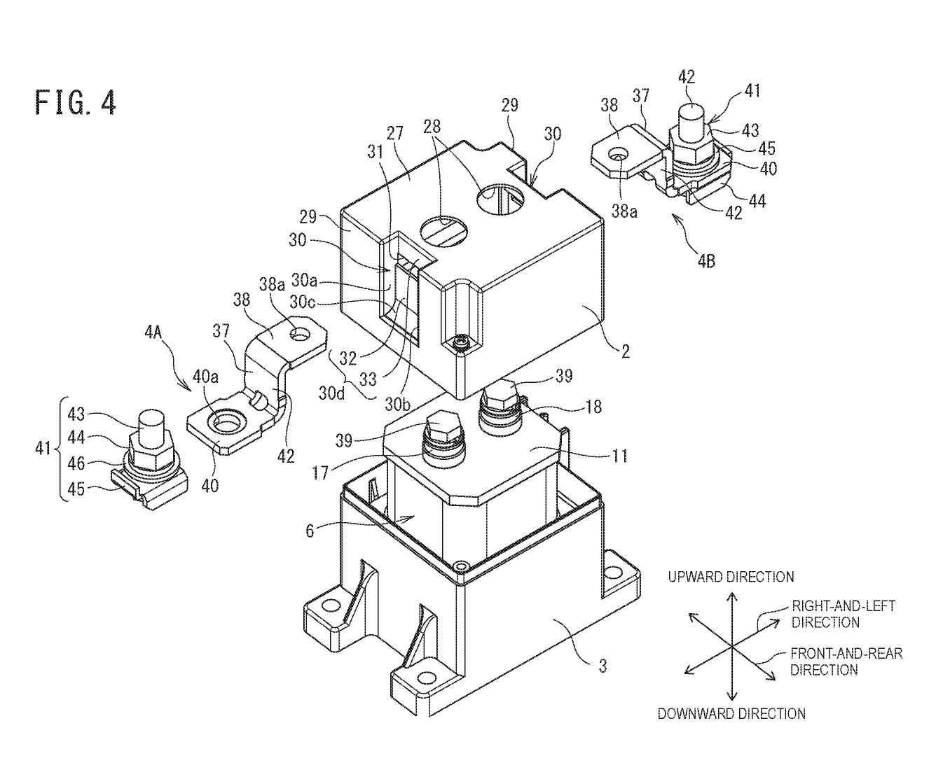

As illustrated in FIG. 4, two fixing screw through-holes 28 are formed in a top plate 27 of the upper insulating case 2 at positions of opposing the heads of the main contact point side fixed contacts 17 and 18.

As illustrated in FIG. 4, a case groove 30 extending in the up-and-down direction is formed in each of right and left side walls 29 of the upper insulating case 2. The case groove 30 formed in the left side of the upper insulating case 2 has a pair of groove side walls 30a and 30b opposing each other, a bottom wall 30c formed on a lower portion between the pair of groove side walls 30a and 30b, and a groove inner wall 30d formed on an inside between the pair of groove side walls 30a and 30b.

An insertion hole 31, which is open in a rectangular shape having the pair of groove side walls 30a and 30b as opening edges in a long-side direction, is formed in the groove inner wall 30d.

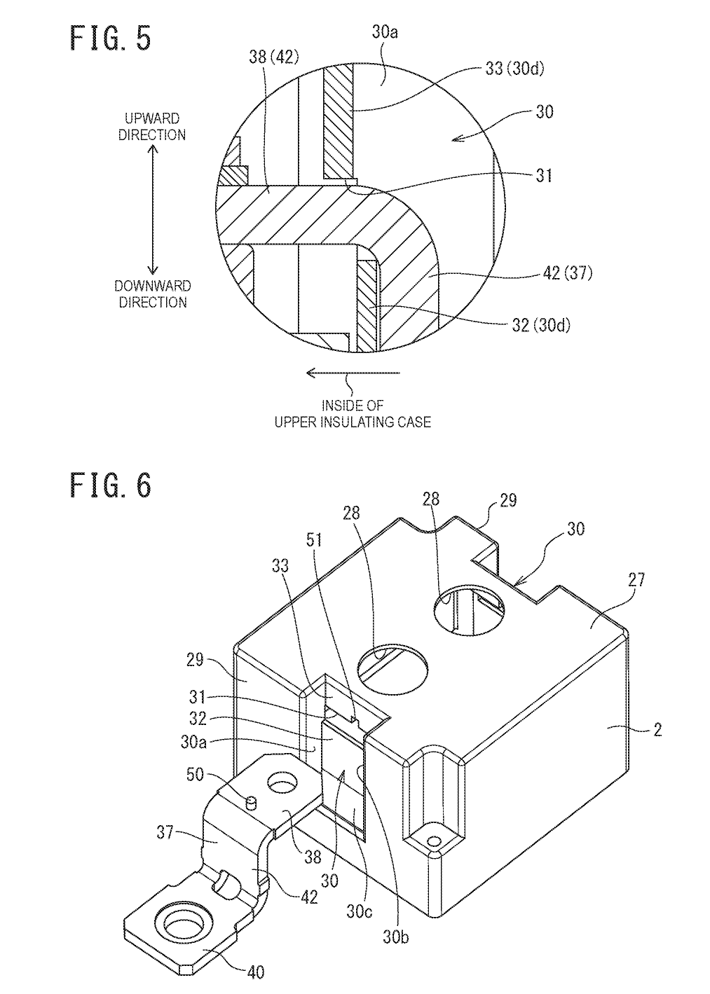

As illustrated in FIGS. 4 and 5, the groove inner wall 30d is formed by a first inner wall 32 and a second inner wall 33, the first inner wall 32 forms a lower opening edge in a short-side direction of the insertion hole 31, and the second inner wall 33 forms an upper opening edge in the short-side direction of the insertion hole 31.

As illustrated in FIG. 5, the first inner wall 32 and the second inner wall 33 form the insertion hole 31 while extending in the up-and-down direction in a stepped shape from the bottom wall 30c to an inside of the upper insulating case 2.

Accordingly, the case groove 30 is formed such that with the insertion hole 31 as a boundary, a top plate 27 side is formed deeper than a lower side of the upper insulating case 2. Therefore, the insertion hole 31 formed by the first inner wall 32 and the second inner wall 33 is molded without becoming an undercut shape by opening a lower mold forming a part of the upper insulating case 2 on a first inner wall 32 side and an upper mold forming the upper insulating case 2 on a second inner wall 33 side when molding the upper insulating case 2, which is a synthetic resin mold case.

As illustrated in FIG. 4, the main contact point external terminal part 4A includes a terminal board 37 formed by a long metal plate, a fixing screw 39 which fixes a one end side terminal 38 of the terminal board 37 to the main contact point side fixed contact 17, and an external terminal 41 fixed to the other end side terminal 40 of the terminal board 37 extending opposite to the one end side terminal 38.

The terminal board 37 has a horizontal sectional shape, which is substantially the same shape as the rectangular insertion hole 31, and has a bent portion 42, which is formed to be bent in a direction where the one end side terminal 38 and the other end side terminal 40 are orthogonal to each other such that the flat one end side terminal 38 and the flat other end side terminal 40 are parallel to each other on a different planes . A screw insertion hole 38a is formed in the one end side terminal 38, and a female screw 40a is formed in the other end side terminal 40.

The external terminal 41 includes a connection screw 43 which is screwed to the female screw 40a of the other end side terminal 40 of the terminal board 37, a nut 44 which is screwed to a screw of the connection screw 43, a first washer 45 disposed between a head of the connection screw 43 and a back surface of the other end side terminal 40, and a second washer 46 disposed between the nut 44 and a front surface of the other end side terminal 40.

The one end side terminal 38 of the terminal board 37 of the main contact point external terminal part 4A having the configuration is inserted inside from the insertion hole 31 of the upper insulating case 2 after the contact device 6 and the electromagnet unit 7 are accommodated inside the upper insulating case 2 and the lower insulating case 3. The screw insertion hole 38a formed in the one end side terminal 38 of the terminal board 37 is aligned with a female screw 17a of the main contact point side fixed contact 17, and the fixing screw 39 inserted from the fixing screw through-hole 28 formed in the top plate 27 of the upper insulating case 2 is screwed to the female screw 17a. Accordingly, as illustrated in FIG. 3, the main contact point external terminal part 4A extends to a lower side in a state where both side surfaces of the bent portion 42 in a width direction, which protrude from the insertion hole 31 of the upper insulating case 2, have abutted against the pair of groove side walls 30a and 30b of the case groove 30, and is assembled in a state where the other end side terminal 40, which has fixed the external terminal 41, has extended in a direction of separating away from the upper insulating case 2.

Also the main contact point external terminal part 4B has the same structure as the main contact point external terminal part 4A, and is assembled in the same procedures.

Herein, a fixed contact according to the invention corresponds to the main contact point side fixed contacts 17 and 18, a movable contact according to the invention corresponds to the main contact point side movable contact 19, an accommodating case according to the invention corresponds to the upper insulating case 2, and side surfaces of the accommodating case according to the invention correspond to the pair of groove side walls 30a and 30b.

Next, operation of the electromagnetic contactor 1 of the first embodiment will be described.

Herein, a power supply device supplying a large current is connected to the main contact point external terminal part 4A, and a load device is connected to the main contact point external terminal part 4B. In addition, an electromagnet unit control device (not illustrated) that controls energization with respect to the exciting coil 26 is connected to the electromagnet unit external terminal parts 5A and 5B.

As illustrated in FIG. 4, the exciting coil 26 of the electromagnet unit 7 is in a non-excited state, and the electromagnet unit 7 is in a released state where excitation power that raises the movable plunger 16 is not generated.

In the released state, the movable plunger 16 is biased in a downward direction by the returning spring 24. For this reason, the main contact point side movable contact 19 of a main contact point mechanism connected to the movable plunger 16 via the connection shaft 14 is separated downwards away from the pair of main contact point side fixed contacts 17 and 18 at a predetermined distance. For this reason, a current path between the pair of main contact point side fixed contacts 17 and 18 is in a blocked state, and the main contact point mechanism 8 is in an opened state.

When the exciting coil 26 of the electromagnet unit 7 is energized by the electromagnet unit control device in the released state, excitation power is generated in the electromagnet unit 7, and the movable plunger 16 is raised upwards against a biasing force of the returning spring 24.

When the movable plunger 16 rises, also the main contact point side movable contact 19 connected to the movable plunger 16 via the connection shaft 14 rises, a movable contact point of the main contact point side movable contact 19 comes into contact with a fixed contact point of the pair of main contact point side fixed contacts 17 and 18 at a contact pressure of the contact spring 20.

For this reason, a large current from the power supply device is supplied to the load device through the main contact point external terminal part 4A, one main contact point side fixed contact 17, the main contact point side movable contact 19, the other main contact point side fixed contact 18, and the main contact point external terminal part 4B, and the main contact point mechanism 8 comes into a closed state (pole closed state).

In a case where current supply to the load device is blocked in the pole closed state of the main contact point mechanism 8, the electromagnet unit control device stops energizing the exciting coil 26 of the electromagnet unit 7.

When the energization of the exciting coil 26 is stopped, the electromagnet unit 7 loses excitation power to move the movable plunger 16 upwards. Consequently, the movable plunger 16 moves downwards by the biasing force of the returning spring 24 and also the connection shaft 14 moves downwards.

Next, operation of connecting or removing a harness of the power supply device to or from the main contact point external terminal part 4A of the electromagnetic contactor 1 of the first embodiment, and of connecting or removing a harness of the load device to or from the main contact point external terminal part 4B will be described.

A harness terminal (not illustrated) joined to the harness of the power supply device is connected to the external terminal 41 provided in the other end side terminal 40 of the main contact point external terminal part 4A, and a harness terminal (not illustrated) joined to the harness of the load device is connected to the external terminal 41 provided in the other end side terminal 40 of the main contact point external terminal part 4B.

In a case where a circular harness terminal is joined to the harness, the harness terminal is inserted into the connection screw 43 in a state where the nut 44 and the second washer 46 of the external terminal 41 are removed. After the second washer 46 is inserted, the nut 44 screwed to the connection screw 43 is fastened with a tool such as a monkey.

When connecting the harness terminal of the power supply device and a harness terminal of an additional device to the external terminals 41 disposed in the other end side terminals 40 of the main contact point external terminal parts 4A and 4B, great torque about each of the other end side terminals 40 acts on the terminal board 37 due to an operation force generated when fastening the nut 44 to the connection screw 43.

The pair of groove side walls 30a and 30b of the case groove 30 receives the great torque acting on the terminal board 37 since the both side surfaces of the bent portion 42 of the terminal board 37 in the width direction, which protrude from the insertion hole 31, extend to the lower side while abutting against the pair of groove side walls 30a and 30b of the case groove 30 over a wide area.

In addition, also in a case where the nut 44 joined to the connection screw 43 is loosened to remove each of the harnesses of the power supply device and the load device from the main contact point external terminal parts 4A and 4B, each pair of groove side walls receives the torque acting on the terminal board 37 since the pair of groove side walls 30a and 30b of the case groove 30 receives the both side surfaces of the bent portion 42 of the terminal board 37 in the width direction over a wide area.

Therefore, the electromagnetic contactor 1 of the first embodiment is capable of suppressing deformation of each one end side terminal 38 of the terminal board 37 fixed to the main contact point side fixed contacts 17 and 18 since the one end side terminal 38 of the terminal board 37 is not rotated by the pair of groove side walls 30a and 30b receiving torque acting on the terminal board 37 when connecting the harnesses of the power supply device and the load device to the main contact point external terminal parts 4A and 4B or when removing the harnesses of the power supply device and the load device. In addition, it is possible to prevent the fixing screw 39 from being loosened since the one end side terminal 38 of the terminal board 37 does not rotate.

In addition, each of the case grooves 30 is formed such that with the insertion hole 31 as a boundary, the top plate 27 side is formed deeper than the lower side of the upper insulating case 2. Therefore, the insertion hole 31 is molded without becoming an undercut shape and a slide type device moving in a direction orthogonal to a direction of opening the upper mold and the lower mold is unnecessary by opening the lower mold forming a part of the upper insulating case 2 on the first inner wall 32 side and the upper mold forming the upper insulating case 2 on the second inner wall 33 side when molding the upper insulating case 2. Consequently, it is possible to reduce molding costs.

### Second Embodiment

Next, FIG. 6 illustrates the upper insulating case 2 configuring the electromagnetic contactor 1 of the second embodiment and the terminal board 37 configuring the main contact point external terminal part 4A.

Since the lower insulating case 3, the contact device 6, and the electromagnet unit 7, which configure the electromagnetic contactor 1 of the second embodiment, have the same structures as the first embodiment, description thereof will be omitted.

A protrusion for assembly 50 is formed on a part of a front surface of the one end side terminal 38 of the terminal board 37 configuring the main contact point external terminal part 4A of the second embodiment. In addition, a notch for assembly 51 is formed in a part of the second inner wall 33 forming the insertion hole 31 of the case groove 30 in a left side surface of the upper insulating case 2 of the second embodiment.

The protrusion for assembly 50 of the terminal board 37 enters the notch for assembly 51 formed in the second inner wall 33 of the upper insulating case 2 when assembling the main contact point external terminal part 4A in a state where the one end side terminal 38 of the terminal board 37 of the main contact point external terminal part 4A is inserted in the insertion hole 31 and the bent portion 42 extends from the one end side terminal 38 to the lower side.

In addition, also the terminal board 37 configuring the main contact point external terminal part 4B of the second embodiment has the same shape as the terminal board 37 configuring the main contact point external terminal part 4A.

A notch according to the invention corresponds to the protrusion for assembly 50.

When the one end side terminal 38 of the terminal board 37 of each of the main contact point external terminal parts 4A and 4B is inserted into the insertion hole 31 of the case groove 30 with orientations of the front surface and the back surface reversed, it is impossible to insert the one end side terminal 38 inside the insertion hole 31 since the protrusion for assembly 50 formed on the one end side terminal 38 comes into contact with an edge of the first inner wall 32 forming the insertion hole 31.

Therefore, by forming the protrusion for assembly 50 on the front surface of the one end side terminal 38 of the terminal board 37 of each of the main contact point external terminal parts 4A and 4B and forming the notch for assembly 51 in a part of each of the second inner walls 33 forming the insertion holes 31 of the upper insulating case 2, the one end side terminal 38 of the terminal board 37 is not inserted into the insertion hole 31 of the upper insulating case 2 even when assembling the main contact point external terminal part with the orientation of the terminal board 37 reversed. Consequently, it is possible to prevent defective assembly of the main contact point external terminal parts 4A and 4B.

Although not illustrated, even when the notch for assembly is formed in a part of each of the front surfaces of the one end side terminals 38 of the terminal boards 37 of the main contact point external terminal parts 4A and 4B and the protrusion for assembly is formed on a part of each of the second inner walls 33, it is possible to prevent defective assembly of the main contact point external terminal parts 4A and 4B.

### Third Embodiment

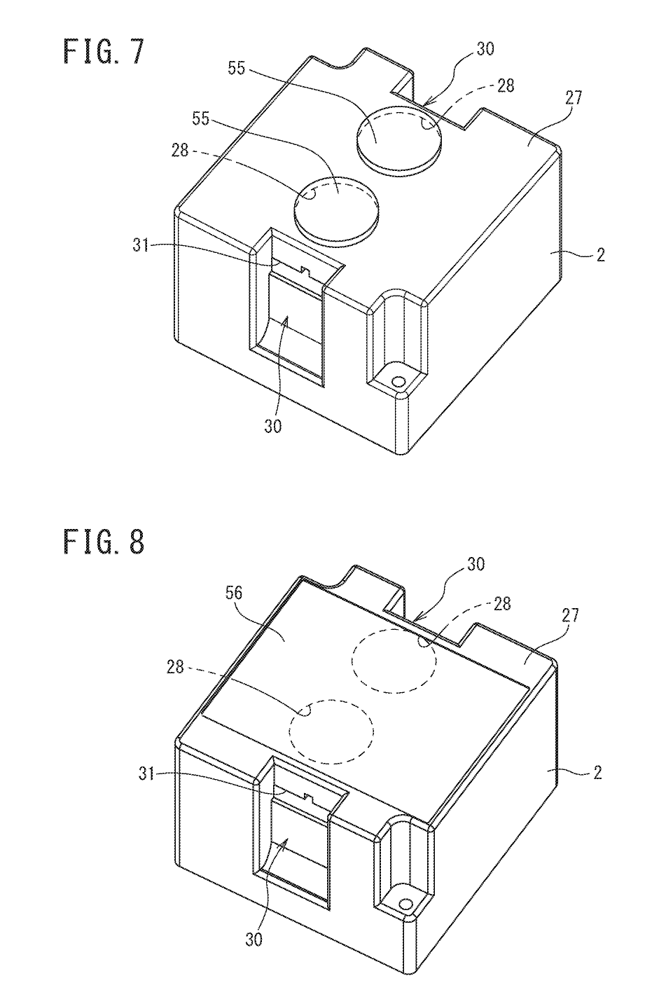

Next, FIG. 7 illustrates the upper insulating case 2 configuring the electromagnetic contactor 1 of the third embodiment.

Synthetic resin blocking members 55 respectively blocking the two fixing screw through-holes 28 formed in the top plate 27 are detachably mounted on the upper insulating case 2 of the third embodiment.

The blocking members 55 are mounted to block the fixing screw through-holes 28 after the one end side terminals 38 of the terminal boards 37 of the main contact point external terminal parts 4A and 4B are put inside the upper insulating case 2 from the insertion holes 31, and the one end side terminals 38 are fixed to the main contact point side fixed contacts 17 and 18 by the fixing screws 39 inserted from the fixing screw through-holes 28.

According to the electromagnetic contactor 1 of the third embodiment, a large current from the power supply device flows to the load device through the main contact point external terminal part 4A, the one main contact point side fixed contact 17, the main contact point side movable contact 19, the other main contact point side fixed contact 18, and the main contact point external terminal part 4B when the exciting coil 26 of the electromagnet unit 7 is energized and the main contact point mechanism 8 comes into the closed state (pole closed state). However, the blocking members 55 block the two fixing screw through-holes 28 formed in the top plate 27 of the upper insulating case 2, and there is no possibility of contacting with the fixing screws 39 fixed to the main contact point side fixed contacts 17 and 18 from the fixing screw through-holes 28. Consequently, it is possible to prevent getting an electric, and thus it is possible to ensure safety.

### Fourth Embodiment

Next, FIG. 8 illustrates the upper insulating case 2 configuring the electromagnetic contactor 1 of the fourth embodiment.

The two fixing screw through-holes 28 are blocked by attaching a resin sheet 56 having electrically insulating properties over a substantially entire area of the top plate 27 of the upper insulating case 2 of the fourth embodiment.

The resin sheet 56 is attached in a state where the fixing screw through-holes 28 are blocked after the one end side terminals 38 of the terminal boards 37 of the main contact point external terminal parts 4A and 4B are put inside the upper insulating case 2 from the insertion holes 31, and the one end side terminals 38 are fixed to the main contact point side fixed contacts 17 and 18 by the fixing screws 39 inserted from the fixing screw through-holes 28.

Since the resin sheet 56 attached to the top plate 27 of the upper insulating case 2 blocks the two fixing screw through-holes 28, there is no possibility of contacting with the fixing screws 39 from the fixing screw through-holes 28 even when a large current flows to the fixing screws 39 fixed to the main contact point side fixed contacts 17 and 18 when the main contact point mechanism 8 is in the pole closed state. Consequently, it is possible to prevent getting an electric shock, and thus it is possible to ensure safety also in the electromagnetic contactor 1 of the fourth embodiment.

### Fifth Embodiment

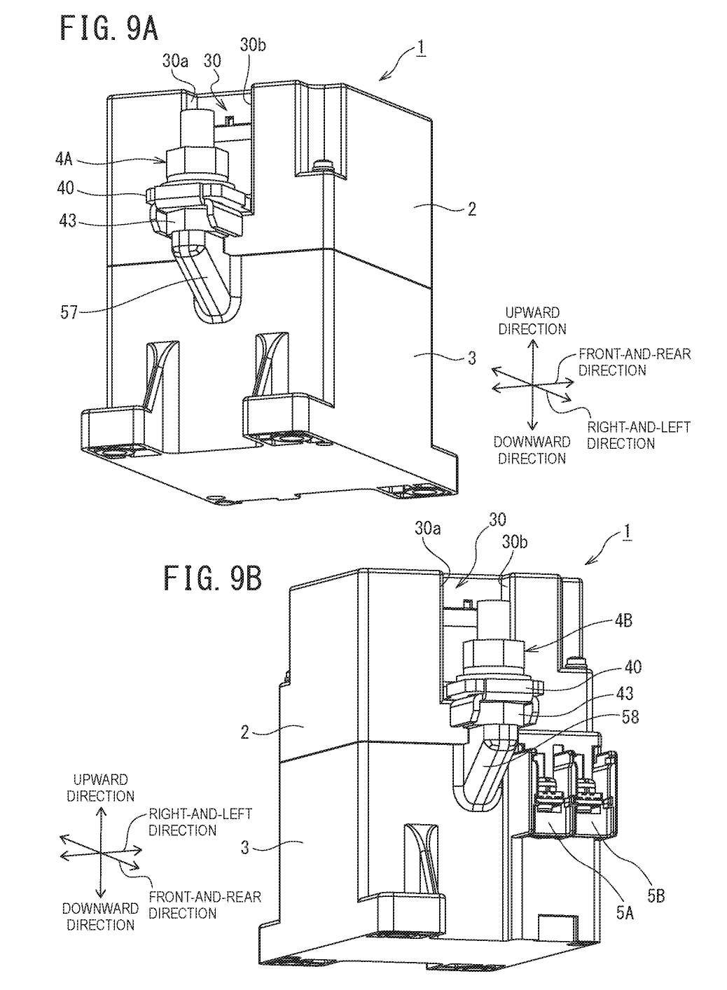

Next, FIGS. 9A and 9B illustrate the electromagnetic contactor 1 of the fifth embodiment.

In the electromagnetic contactor 1 of the fifth embodiment, terminal receiving portions 57 and 58 protruding from right and left side surfaces of the lower insulating case 3 abut against, from the lower side, the connection screws 43 of the main contact point external terminal parts 4A and 4B protruding from the right and left side walls of the upper insulating case 2 to the outside.

When connecting or removing the harness of the power supply device to or from the main contact point external terminal part 4A or when connecting or removing the harness of the load device to or from the main contact point external terminal part 4B, the operation is performed while pushing the nut 44 screwed to the connection screw 43 to the lower side with a tool such as a monkey. Therefore, a deforming force of deforming the other end side terminal 40 to the lower side acts on the terminal board 37.

However, in the fifth embodiment, each of the other end side terminals 40 receives a deforming force of deforming to the lower side since the terminal receiving portions 57 and 58 protruding from the right and left side surface of the lower insulating case 3 abut against, from the lower side, the connection screws 43 of the main contact point external terminal parts 4A and 4B.

Therefore, by the terminal receiving portions 57 and 58 provided on the lower insulating case 3 abutting against, from the lower side, the connection screws 43 of the main contact point external terminal parts 4A and 4B, the electromagnetic contactor 1 of the fifth embodiment receives deforming forces of deforming the other end side terminals 40 to the lower side, which act on the terminal boards 37 when connecting the harnesses of the power supply device and the load device to the main contact point external terminal parts 4A and 4B or when removing the harnesses of the power supply device and the load device.

Accordingly, the electromagnetic contactor 1 of the fifth embodiment is also capable of suppressing deformation of the terminal boards 37, in which the other end side terminals 40 deform to the lower side.

### Sixth Embodiment

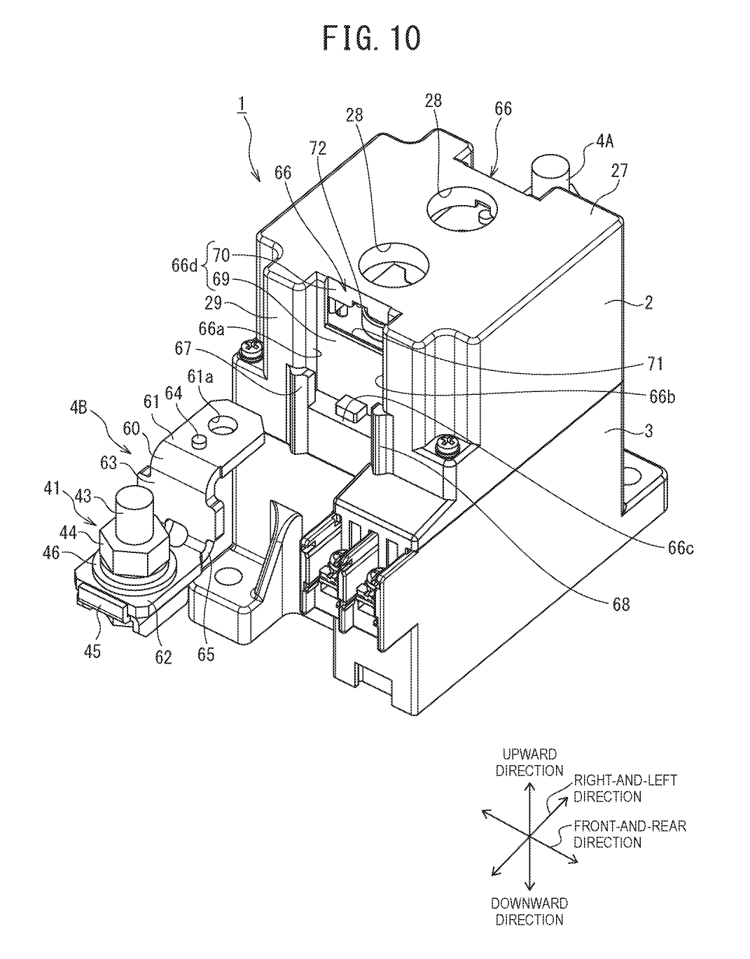

Next, FIGS. 10 to 13 illustrate the electromagnetic contactor 1 of the sixth embodiment.

As illustrated in FIG. 10, the main contact point external terminal part 4B of the sixth embodiment includes a terminal board 60 formed by a long metal plate.

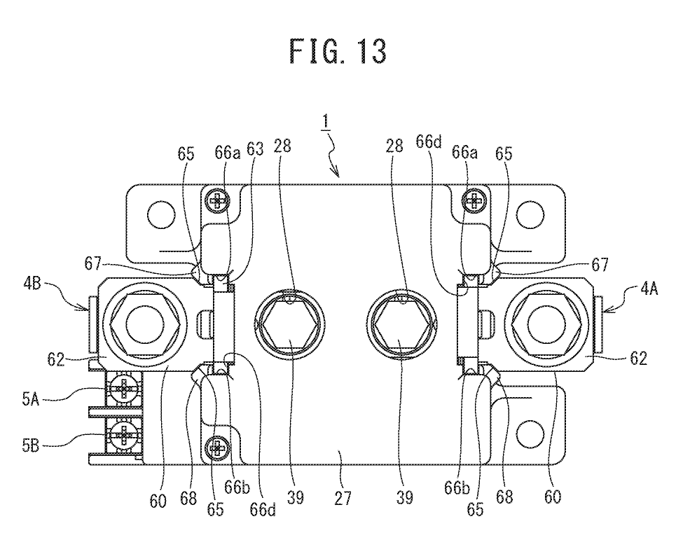

The terminal board 60 has a shape different from the shape of the terminal board 37 of the first embodiment to the fifth embodiment, which is in contact from the one end side terminal 38 to the other end side terminal 40 over substantially the same width-direction dimension. In the terminal board 60, a one end side terminal 61 is formed such that a width-direction dimension of the one end side terminal is set to be smaller than the width-direction dimension of a bent portion 63, and neck portions 65 are formed at width-direction both ends of a part between the other end side terminal 62 and the bent portion 63, which have substantially the same width-direction dimension (refer to FIG. 13). A screw insertion hole 61a inserted into the fixing screw 39 is formed in the one end side terminal 61, and a protrusion for assembly 64 is formed on a front surface of the one end side terminal.

Also the main contact point external terminal part 4A of the sixth embodiment is a member having the same structure as the main contact point external terminal part 4B of the sixth embodiment described above.

A case groove 66 extending in the up-and-down direction is formed in the side wall 29 of the upper insulating case 2 in the right-and-left direction, and a pair of protrusions for holding 67 and 68 is formed on edges of the case groove 66.

The case groove 66 of the upper insulating case 2 has a pair of groove side walls 66a and 66b opposing each other, a bottom wall 66c formed on a lower portion between the pair of groove side walls 66a and 66b, and a groove inner wall 66d formed on an inside between the pair of groove side walls 66a and 66b.

The groove inner wall 66d is formed by a first inner wall 69 and a second inner wall 70, and a rectangular shape insertion hole 71 is formed by the first inner wall 69 and the second inner wall 70.

The long-side direction dimension of the insertion hole 71 is set to be substantially the same dimension as the width-direction dimension of the one end side terminal 61 of the terminal board 60, and the short-side direction dimension of the insertion hole 71 is set to be a dimension larger than the plate thickness dimension of the one end side terminal 61 of the terminal board 60.

A notch for assembly 72 is formed in apart of the second inner wall 70 forming the insertion hole 71.

The pair of protrusions for holding 67 and 68 protrudes parallel to the groove inner wall 66d (first inner wall 69) in a direction of respectively opposing the opening edges close to the bottom wall 66c of the case groove 66, and a distance between the groove inner wall 66d and the pair of protrusions for holding 67 and 68 is set to the plate thickness dimension of the bent portion 63 of the terminal board 60.

The first inner wall 69 and the second inner wall 70, as the first inner wall 32 and the second inner wall 33 described in the first embodiment, form the insertion hole 71 while extending in the up-and-down direction in a stepped shape from the bottom wall 66c to the inside of the upper insulating case 2. Accordingly, the insertion hole 71 formed by the first inner wall 69 and the second inner wall 70 is molded without becoming an undercut shape by opening a lower mold forming a part of the upper insulating case 2 on a first inner wall 69 side and an upper mold forming the upper insulating case 2 on a second inner wall 70 side when molding the upper insulating case 2, which is a synthetic resin mold case.

Next, the procedures of assembling the main contact point external terminal part 4B having the configuration into the main contact point mechanism 8 accommodated in the upper insulating case 2 will be described.

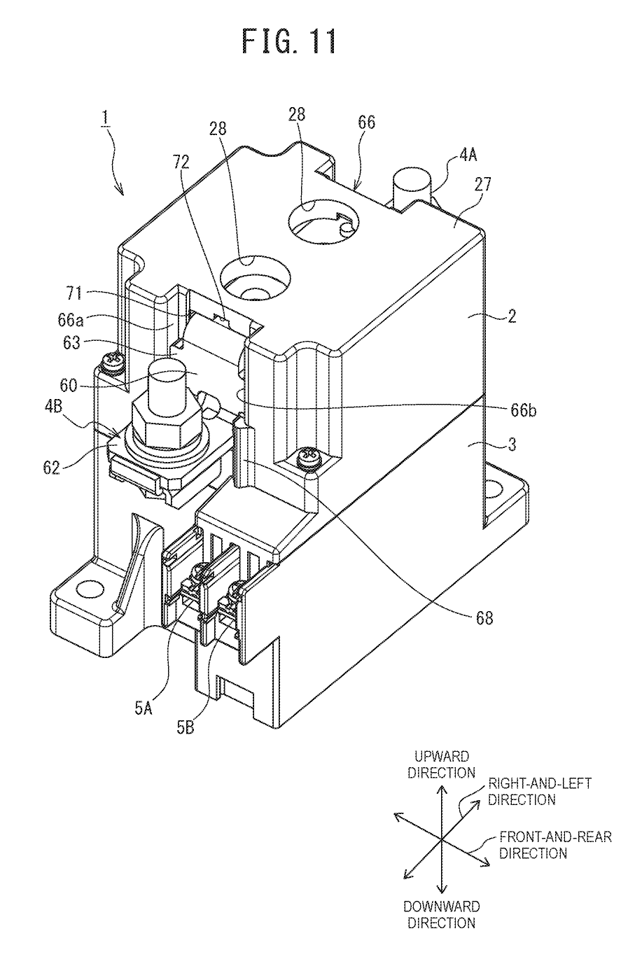

First, the one end side terminal 61 is inserted into the insertion hole 71 in a state where the protrusion for assembly 64 of the terminal board 60 is inserted in the notch for assembly 72 formed in an opening periphery of the insertion hole 71, as illustrated in FIG. 11. At this time, the bent portion 63 of the terminal board 60 is caused to abut against the groove inner wall 66d of the case groove 66 at a position above the pair of protrusions for holding 67 and 68.

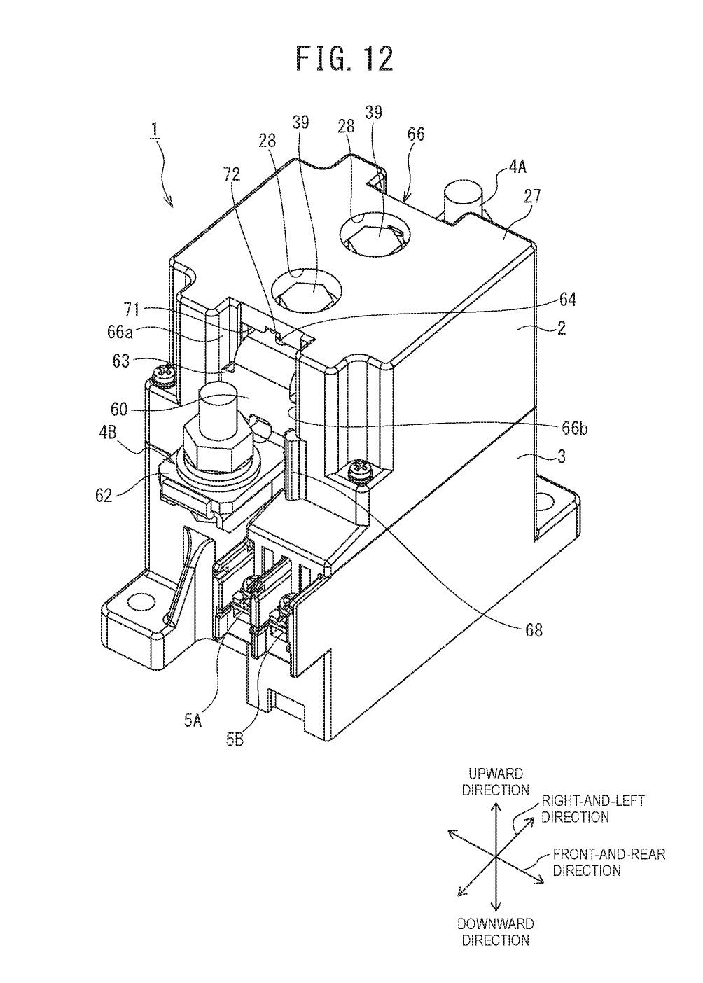

Next, the entire main contact point external terminal part 4B is lowered to a lower insulating case 3 side as illustrated in FIGS. 12 and 13. At this time, in a state where the bent portion 63 which has abutted against the groove inner wall 66d moves to a portion between the pair of protrusions for holding 67 and 68 and the neck portions 65 are located at an outer periphery of the pair of protrusions for holding 67 and 68, the other end side terminal 62 of the terminal board 60 is disposed in a state of extending in a direction of separating away from the upper insulating case 2. Then, the main contact point external terminal part 4B is assembled into the main contact point mechanism 8 by fixing the one end side terminal 61 of the terminal board 60 to the main contact point side fixed contact 17 via the fixing screw 39.

In addition, also the main contact point external terminal part 4A is assembled into the main contact point mechanism 8 in the same procedures as the main contact point external terminal part 4B.

When connecting the harness terminal of the power supply device and a harness terminal of an additional device to the external terminals 41 provided in the other end side terminals 62 of the main contact point external terminal parts 4A and 4B of the sixth embodiment, great torque about each other end side terminal 62 acts on the terminal board 60.

It is possible to suppress deformation of the one end side terminal 61 since the both side surfaces of the bent portion 63 of the terminal board 60 in the width direction, which protrude from the insertion hole 71, extend to the lower side while abutting against the pair of groove side walls 66a and 66b of the case groove 66 over a wide area, and the pair of groove side walls 66a and 66b receives the great torque acting on the terminal board 60. In addition, it is also possible to prevent torsional deformation of the terminal board 60 since both end portions of the bent portion 63 of the terminal board 60 in the width-direction are sandwiched between the groove inner wall 66d and the pair of protrusions for holding 67 and 68.

In addition, also in a case where the nuts 44 joined to the connection screws 43 are loosened to remove the harnesses of the power supply device and the load device from the main contact point external terminal parts 4A and 4B, it is possible to receive great torque acting on the terminal boards 60 and it is also possible to prevent torsional deformation of the terminal boards 60.

In addition, in the sixth embodiment, the first inner wall 69 and the second inner wall 70 of the upper insulating case 2 form the insertion hole 71 while extending in the up-and-down direction in a stepped shape from the bottom wall 66c to the inside of the upper insulating case 2.

Accordingly, each of the case grooves 66 is formed such that with the insertion hole 71 as a boundary, the top plate 27 side is formed deeper than the lower side of the upper insulating case 2. Therefore, the insertion hole 71 is molded without becoming an undercut shape and a slide type device moving in a direction orthogonal to a direction of opening an upper mold and a lower mold is unnecessary by opening the lower mold forming a part of the upper insulating case 2 on the first inner wall 69 side and the upper mold forming the upper insulating case 2 on the second inner wall 70 side when molding the upper insulating case 2. Consequently, it is possible to reduce molding costs.

### REFERENCE SIGNS LIST

1: electromagnetic contactor

2: upper insulating case

3: lower insulating case

4A, 4B: main contact point external terminal part

5A, 5B: electromagnet unit external terminal part

6: contact device

7: electromagnet unit

8: main contact point mechanism

9: accommodating case

10: bonding member

11: top plate

12: magnetic yoke

12a: through-hole

13: cap

14: connection shaft

14a: enlarged diameter portion

15: fixing iron core

15a: returning spring accommodating recess

16: movable plunger

16a: returning spring accommodating recess

17, 18: pair of main contact point side fixed contact

17a, 18a: female screw

19: main contact point side movable contact

20: contact spring

21: main contact point mechanism accommodating chamber

22: arc-extinguishing vessel

23: lower magnetic yoke

24: returning spring

25: spool

26: exciting coil

27: top plate

28: fixing screw through-hole

29: side wall

30: case groove

30a, 30b: groove side wall

30c: bottom wall

30d: groove inner wall

31: insertion hole

32: first inner wall

33: second inner wall

37: terminal board

38: one end side terminal

38a: screw insertion hole

39: fixing screw

40: other end side terminal

40a: female screw

41: external terminal

42: bent portion

43: connection screw

44: nut

45: first washer

46: second washer

50: protrusion for assembly

51: notch for assembly

55: blocking member

56: resin sheet

57, 58: terminal receiving portion

60: terminal board

61: one end side terminal

61a: screw insertion hole

62: other end side terminal

63: bent portion

65: neck portion

64: protrusion for assembly

66: case groove

67, 68: protrusion for holding

66a, 66b: groove side wall

66c: bottom wall

66d: groove inner wall

69: first inner wall

70: second inner wall

71: insertion hole

72: notch for assembly

1. A contact device comprising:
an accommodating case configured to accommodate a main contact point mechanism including a fixed contact; and
a terminal board penetrating through an insertion hole formed in the accommodating case,
wherein one end side of the terminal board is fixed to the fixed contact, and another end side of the terminal board is extending in a direction of separating away from the accommodating case to be electrically connected with an external terminal, and
wherein a bent portion surface-contacting with a side surface of the accommodating case is formed in the terminal board.

2. The contact device according to claim 1,
wherein a case groove to accommodate the bent portion is provided in the accommodating case,
the insertion hole is formed inside of the case groove.

3. The contact device according to claim 2,
wherein, with the insertion hole as a boundary, a top plate side of the case groove is formed to be deeper than an accommodating case attached side of the case groove.

4. The contact device according to claim 2,
wherein a protrusion for assembly is provided on any one of the insertion hole and the terminal board to be located in the insertion hole, and a notch corresponding to the protrusion for assembly is provided in the other one.

5. The contact device according to claim 1,
wherein a protrusion for holding is provided on any one of the terminal board and the accommodating case contacting with the terminal board, and a neck portion corresponding to the protrusion for holding is provided in the other one.

6. The contact device according to claim 1,
wherein a fixing screw through-hole configured to be used to allow a fixing screw to be screwed to the fixed contact is formed in a top plate of the accommodating case, and
the fixing screw through-hole is blocked by an electrically insulating blocking member.

7. The contact device according to claim 1,
wherein a fixing screw through-hole configured to be used to allow a fixing screw to be screwed to the fixed contact is formed in a top plate of the accommodating case, and
an electrically insulating flexible sheet is attached to an entire surface of the top plate.

8. The contact device according to claim 1,
wherein a terminal receiving portion configured to receive the external terminal from below is formed on the accommodating case.

9. An electromagnetic contactor comprising:
the contact device according to claim 1; and
an electromagnet unit configured to move a movable contact disposed to be capable of contacting with or separating away from the fixed contact.

10. The contact device according to claim 3,
wherein a protrusion for assembly is provided on any one of the insertion hole and the terminal board to be located in the insertion hole, and a notch corresponding to the protrusion for assembly is provided in the other one.

11. The contact device according to claim 2,
wherein a protrusion for holding is provided on any one of the terminal board and the accommodating case contacting with the terminal board, and a neck portion corresponding to the protrusion for holding is provided in the other one.

12. The contact device according to claim 3,
wherein a protrusion for holding is provided on any one of the terminal board and the accommodating case contacting with the terminal board, and a neck portion corresponding to the protrusion for holding is provided in the other one.

13. The contact device according to claim 2,
wherein a fixing screw through-hole configured to be used to allow a fixing screw to be screwed to the fixed contact is formed in a top plate of the accommodating case, and
the fixing screw through-hole is blocked by an electrically insulating blocking member.

14. The contact device according to claim 3,
wherein a fixing screw through-hole configured to be used to allow a fixing screw to be screwed to the fixed contact is formed in a top plate of the accommodating case, and
the fixing screw through-hole is blocked by an electrically insulating blocking member.

15. The contact device according to claim 2,
wherein a fixing screw through-hole configured to be used to allow a fixing screw to be screwed to the fixed contact is formed in a top plate of the accommodating case, and
an electrically insulating flexible sheet is attached to an entire surface of the top plate.

16. The contact device according to claim 3,
wherein a fixing screw through-hole configured to be used to allow a fixing screw to be screwed to the fixed contact is formed in a top plate of the accommodating case, and
an electrically insulating flexible sheet is attached to an entire surface of the top plate.

17. The contact device according to claim 2,
wherein a terminal receiving portion configured to receive the external terminal from below is formed on the accommodating case.

18. The contact device according to claim 3,
wherein a terminal receiving portion configured to receive the external terminal from below is formed on the accommodating case.

19. An electromagnetic contactor comprising:
the contact device according to claim 2; and
an electromagnet unit configured to move a movable contact disposed to be capable of contacting with or separating away from the fixed contact.

20. An electromagnetic contactor comprising:
the contact device according to claim 3; and
an electromagnet unit configured to move a movable contact disposed to be capable of contacting with or separating away from the fixed contact.
